(19) United States
(12) Patent Application Publication
(10) Pub. No.: US 2018/0247449 A1
(43) Pub. Date: Aug. 30, 2018

(54) METHOD AND APPARATUS FOR CONTROLLING 3D MEDICAL IMAGE

(71) Applicant: MEDICALIP CO., LTD., Chuncheon-si (KR)

(72) Inventors: Sang Joon Park, Seoul (KR); Doo Hee Lee, Gwangmyeong-si (KR)

(73) Assignee: MEDICALIP CO., LTD., Chuncheon-si (KR)

(21) Appl. No.: 15/472,048

(22) Filed: Mar. 28, 2017

(30) Foreign Application Priority Data
Feb. 28, 2017 (KR) 10-2017-0025867

(51) Int. Cl. G06T 17/10; G06T 19/00

(52) U.S. Cl. CPC G06T 17/10; G06T 2210/41; G06T 19/006

(57) ABSTRACT

Provided is a method and apparatus for controlling a three-dimensional (3D) medical image. The apparatus renders a medical image into a 3D object displayed in a virtual space, and scales up, scales down, rotates, or moves the 3D object or displays a cross section thereof according to a control signal.

### CROSS-REFERENCE TO RELATED APPLICATION

This application claims the benefit of Korean Patent Application No. 10-2017-0025867, filed on Feb. 28, 2017, in the Korean Intellectual Property Office, the disclosure of which is incorporated herein in its entirety by reference.

### BACKGROUND

### 1. Field

One or more embodiments relate to methods and apparatuses for controlling a three-dimensional (3D) medical image, and more particularly, to methods and apparatuses for rendering a 3D medical image into a 3D object of virtual reality (VR) or augmented reality (AR) and controlling the same.

### 2. Description of the Related Art

Virtual reality (VR) is a technology of artificially generating pseudo-perception stimuli and directly presenting the pseudo-perception stimuli to human sensory system to generate a sense of seeming to exist in a separate space different from an actual space. It may be possible to artificially reproduce or expand human experience through the virtual reality. The virtual reality may have three factors of “three-dimensional (3D) spatiality”, “real-time interaction”, and “self-projection”, and these factors may be closely related to the medical field in regard to “perception and recognition (e.g., spatial perception)”, “consciousness and action”, and “experience and emotion” of humans.

In the medical field, effective 3D medical image control may be difficult due to limited input/output devices (e.g., mouses, keyboards, and monitors) and thus there may be many cases of complaining about cognitive/physical fatigue.

### SUMMARY

One or more embodiments include methods and apparatuses for rendering a three-dimensional (3D) medical image into a 3D object of virtual reality (VR) or augmented reality (AR) and easily controlling the same through various interfaces.

Additional aspects will be set forth in part in the description which follows and, in part, will be apparent from the description, or may be learned by practice of the presented embodiments.

According to one or more embodiments, a method of controlling a medical image includes: receiving a medical image; rendering the medical image into a three-dimensional (3D) object; and scaling up, scaling down, rotating, or moving the 3D object or displaying a cross section thereof according to a control signal, wherein the displaying of the cross section includes: determining a voxel of the medical image corresponding to a section where a virtual plane and the 3D object meet together; and determining and displaying color, brightness, or chroma on the virtual plane based on a signal intensity represented by the voxel of the medical image.

According to one or more embodiments, an apparatus for controlling a medical image includes: an input unit receiving a medical image; a rendering unit rendering the medical image into a three-dimensional (3D) object; and a control unit scaling up, scaling down, rotating, or moving the 3D object or displaying a cross section thereof according to a control signal, wherein when receiving a cross section control signal, the control unit determines color, brightness, or chroma based on a signal intensity represented by a voxel of the medical image corresponding to a section where a virtual plane and the 3D object meet together and displays the determined color, brightness, or chroma on the virtual plane.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating a schematic configuration of a system for rendering a medical image into a three-dimensional (3D) object and controlling the same according to an embodiment of the inventive concept;

FIG. 2 is a diagram illustrating a configuration of a medical image control apparatus for controlling a 3D object of a medical image according to an embodiment of the inventive concept;

FIG. 3 is a diagram illustrating a method of displaying a 3D object rendered from a medical image according to an embodiment of the inventive concept;

FIG. 4 is a diagram illustrating a method of scaling up or down a 3D object of a medical image according to an embodiment of the inventive concept;

FIGS. 5 and 6 are diagrams illustrating a method of controlling a signal intensity range of a medical image according to an embodiment of the inventive concept;

FIGS. 7 and 8 are diagrams illustrating a method of controlling a position of a signal intensity range according to an embodiment of the inventive concept;

FIG. 9 is a diagram illustrating a method of measuring a distance of a 3D object of a medical image according to an embodiment of the inventive concept;

FIGS. 10 and 11 are diagrams illustrating a method of rotating a 3D object of a medical image according to an embodiment of the inventive concept;

FIGS. 12 to 15 are diagrams illustrating a method of displaying a cross section of a 3D object of a medical image according to an embodiment of the inventive concept;

FIG. 16 is a diagram illustrating a flow of an embodiment of a medical image control method according to the inventive concept; and

FIG. 17 is a diagram illustrating a flow of an embodiment of a method of displaying a medical image cross section according to the inventive concept.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

Hereinafter, methods and apparatuses for controlling a three-dimensional (3D) medical image according to the inventive concept will be described in detail with reference to the accompanying drawings.

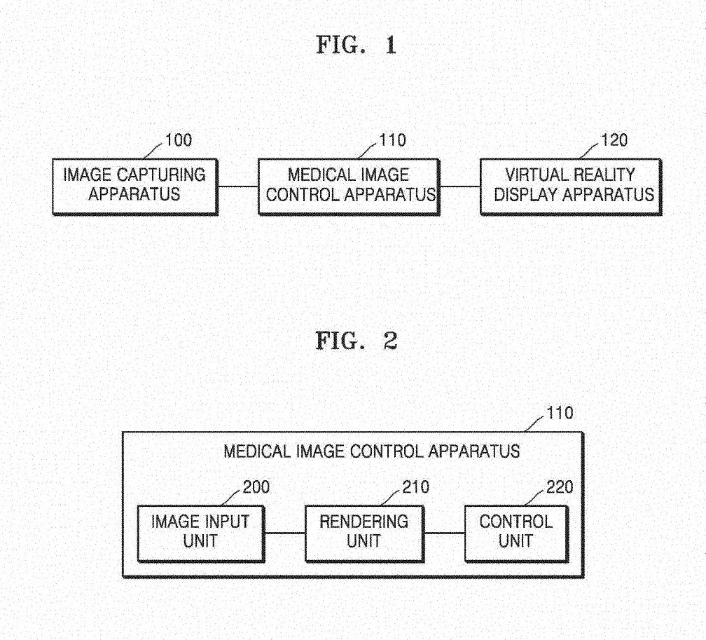

FIG. 1 is a diagram illustrating a schematic configuration of a system for rendering a medical image into a 3D object and controlling the same according to an embodiment of the inventive concept.

Referring to FIG. 1, the system according to an embodiment of the inventive concept may include an image capturing apparatus 100, a medical image control apparatus 110, and a virtual reality display apparatus 120.

The image capturing apparatus 100 may be, for example, an apparatus capturing a 3D image of the inside of a body. The image capturing apparatus 100 may include, for example, but not limited to, a computed tomography (CT) apparatus or a magnetic resonance imaging (MRI) apparatus and may include any apparatus that may acquire a 3D image of the inside of a body.

The medical image control apparatus 110 may receive a 3D medical image captured by the image capturing apparatus 100, may render the 3D medical image into a 3D object displayed in virtual reality or augmented reality, and may scale up, scale down, move, or rotate the 3D object or display a cross section thereof according to a control signal input through various user interface apparatuses. The medical image control apparatus 110 is illustrated as directly receiving a medical image from the image capturing apparatus 100; however, the medical image control apparatus 110 is not limited thereto and may receive a medical image through any electronic medium (e.g., compact disk (CD), digital versatile disk (DVD), or USB memory). The medical image control apparatus 110 may receive the medical image as a DICOM (Digital Imaging and Communication in Medicine) file.

The medical image control apparatus 110 may render the entire medical image or may extract a particular region desired by a user (hereinafter referred to as an interesting region) from the medical image and render the interesting region into a 3D object. An interesting region may be extracted from a medical image by various methods, and examples thereof are disclosed in Korean Patent No. 10-1482247 (Method and Apparatus for Extracting Airway) and Korean Patent No. 10-1514003 (Method and Apparatus for Extracting Lunglobe).

The medical image control apparatus 110 may render a 3D medical image including voxels in the form of a polygon obtained by reconstructing a surface as a mesh, or in the form of a volume represented as a set of hexahedrons. Alternatively, the medical image control apparatus 110 may render the medical image in a mixture of a polygon form and a volume form. In addition, the medical image control apparatus 110 may render a 3D object from the medical image by using various conventional rendering methods.

The virtual reality display apparatus 120 may display the 3D object rendered by the medical image control apparatus 110 in virtual reality or augmented reality. The virtual reality display apparatus 120 may be a head-mounted display apparatus worn on the user's head or may be of various types such as smart glasses or general display apparatuses. The virtual reality display apparatus 120 is not limited thereto and may include any apparatus that may display a rendered 3D object. According to an embodiment, the medical image control apparatus 110 and the virtual reality display apparatus 120 may be implemented as a single apparatus.

There are various interface apparatuses allowing the user to easily control the 3D object in the virtual reality or augmented reality. For example, the user itself or a user interface apparatus may be projected in the virtual reality or augmented reality. For example, the user may control the movement or rotation of the 3D object through the motion of its own hand projected in the virtual reality or augmented reality.

For example, the user interface apparatus may be of a glove type worn on the hand, and the medical image control apparatus 110 may project a glove-type interface apparatus in the virtual reality or augmented reality, detect the position or motion of the hand in the virtual space, and then perform a corresponding control operation. In addition, various types of user interface apparatuses may be used to generate various control signals by detecting the user's motions projected in the virtual reality or augmented reality, and the present embodiment is not limited to a particular user interface apparatus.

However, for convenience of description, in the following description, it is assumed that the user interface apparatus is of a type capable of being held in both hands of the user and includes, for example, a button, a track ball, or a touch pad. The medical image control apparatus 110 may perform various control operations such as the movement or rotation of the 3D object and the display of a cross section thereof based on the press of the button of the user interface apparatus or the motion of the user interface apparatus projected in the space of virtual reality or augmented reality.

FIG. 2 is a diagram illustrating a configuration of a medical image control apparatus for controlling a 3D object of a medical image according to an embodiment of the inventive concept.

Referring to FIG. 2, the medical image control apparatus 110 may include an image input unit 200, a rendering unit 210, and a control unit 220.

The image input unit 200 may receive a 3D medical image such as a CT image. The 3D medical image may include voxels and may represent a tissue as a contrast of signal intensity. For example, in a CT image, the signal intensity of a lung tissue may be about −400 HU (Hounsfield Unit) or less, and the internal signal intensity of an airway containing air may be about −950 HU.

According to an embodiment, the image input unit 200 may further perform a preprocessing process on the 3D medical image. Through the preprocessing process, the noise of the medical image may be removed to improve the image quality thereof. The preprocessing process may include various conventional methods. For example, the image input unit 200 may perform the preprocessing process by using anisotropic diffusion (AD) filtering. Since the AD filtering is a conventional algorithm that is widely used to effectively remove the noise while preserving a reliable boundary, detailed descriptions thereof will be omitted for conciseness.

The rendering unit 210 may render the 3D medical image into a 3D object to be displayed in virtual reality or augmented reality. The rendering unit 210 may render the 3D medical image in the form of a polygon obtained by reconstructing a surface as a mesh, or in the form of a volume represented as a set of hexahedrons. Various conventional methods may be used to render an image including voxels into a 3D object having a surface.

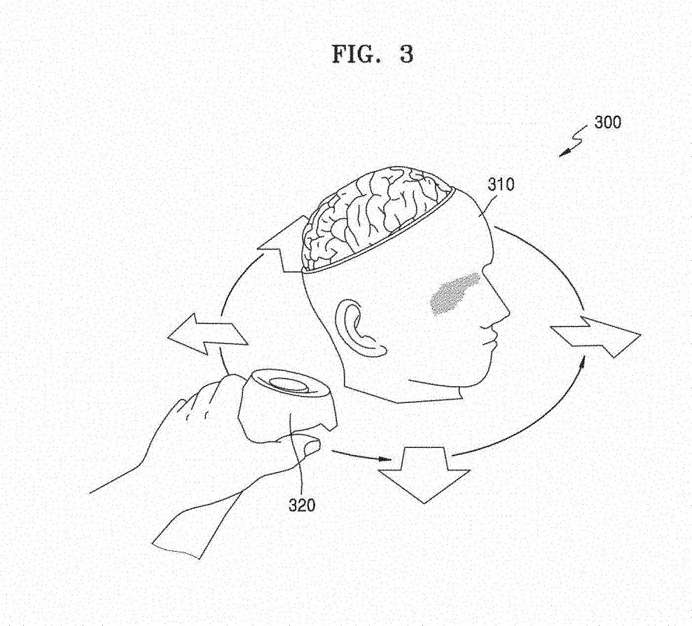

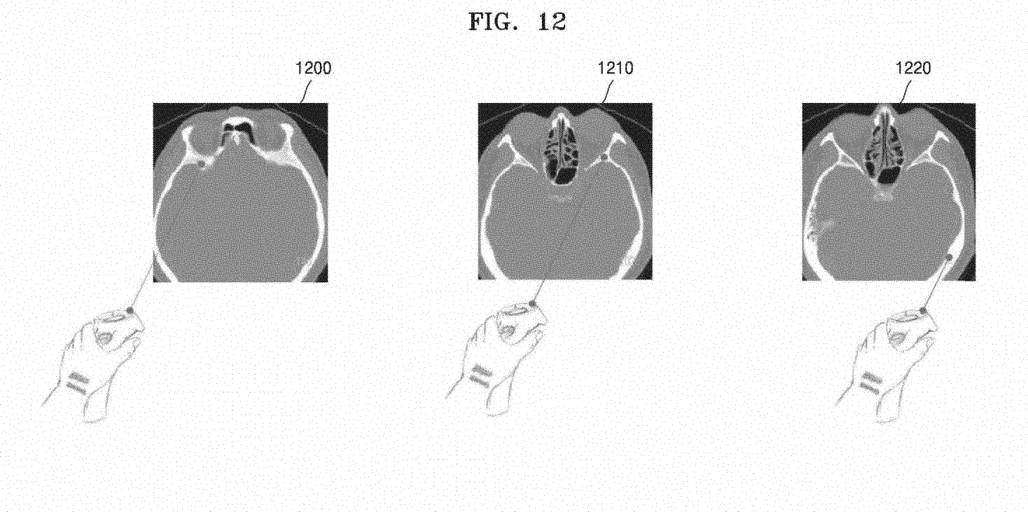

The control unit 220 may perform various control operations, such as scaleup, scaledown, movement, signal intensity range or position change, and cross section display, on the 3D object displayed in the virtual reality or augmented reality according to the control signals received from the user interface apparatus. Examples of a 3D object control method are illustrated in FIGS. 3 to 14. The present embodiment may easily display the cross sections of the 3D object at various positions or angles through the user's motion capture in addition to the control such as the scaleup or scaledown of the 3D object. The cross section display will be described again with reference to FIGS. 12 to 15.

FIG. 3 is a diagram illustrating a method of displaying a 3D object rendered from a medical image according to an embodiment of the inventive concept.

Referring to FIG. 3, the medical image control apparatus may render a medical image into a 3D object 310 and display the same through virtual reality or augmented reality (hereinafter referred to as virtual space) 300. For example, the medical image control apparatus may perform movement, rotation, scaleup, or scaledown or may display a cross section thereof while showing the 3D object to the user through the user's motion capture projected in the virtual space.

For example, the medical image control apparatus may determine the position, motion, inclination (angle), or movement speed of an interface apparatus 320 held in the user's hand in the virtual space and then perform a predetermined control operation according to each motion. When the interface apparatus 320 is held in each of both hands of the user, the medical image control apparatus may detect the distance between two interface apparatuses and the relative movement direction thereof and perform a corresponding control operation.

As another example, when the movement or rotation of the 3D object is controlled according to the movement of the interface apparatus 320, the 3D object may undesirably move even when the user moves a little. Thus, only when a particular button of the interface apparatus 320 is pressed, the medical image control apparatus may capture the motion of the interface apparatus 320 and then perform a corresponding control operation.

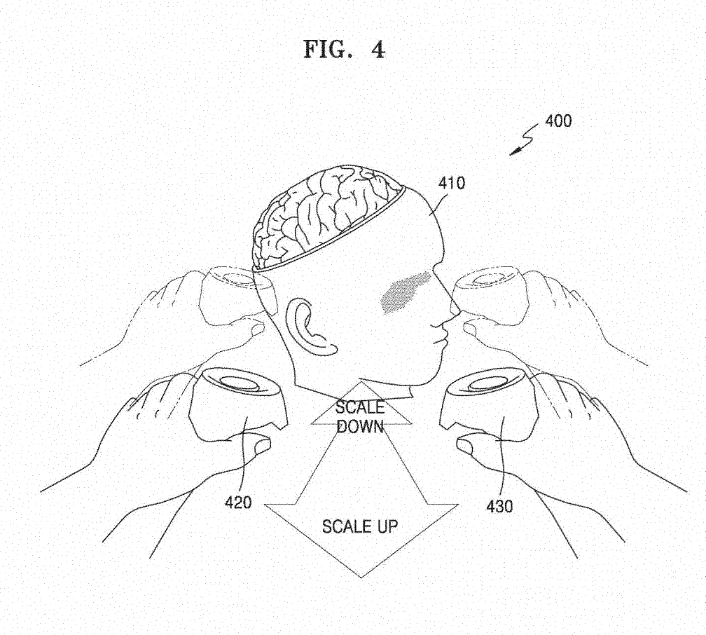

FIG. 4 is a diagram illustrating a method of scaling up or down a 3D object of a medical image according to the inventive concept.

Referring to FIG. 4, when the user presses a particular button 400 and pushes interface apparatuses 420 and 430 held in both hands of the user in a virtual space, the medical image control apparatus may scale down a 3D object 410. On the other hand, when the user pulls the interface apparatuses 420 and 430 held in both hands, the medical image control apparatus may scale up the 3D object 410. The medical image control apparatus may determine a scaleup/scaledown factor in proportion to the movement distance of the interface apparatuses 420 and 430.

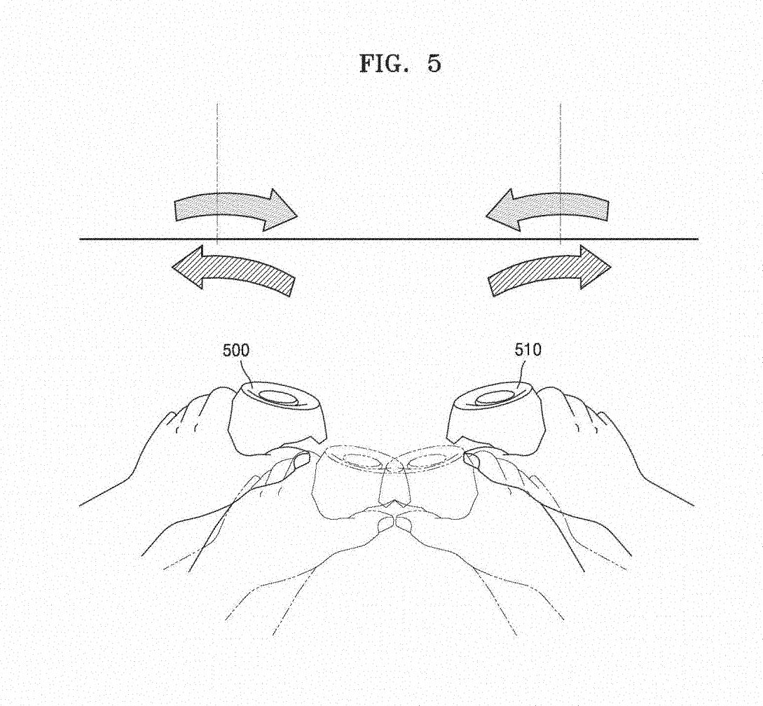

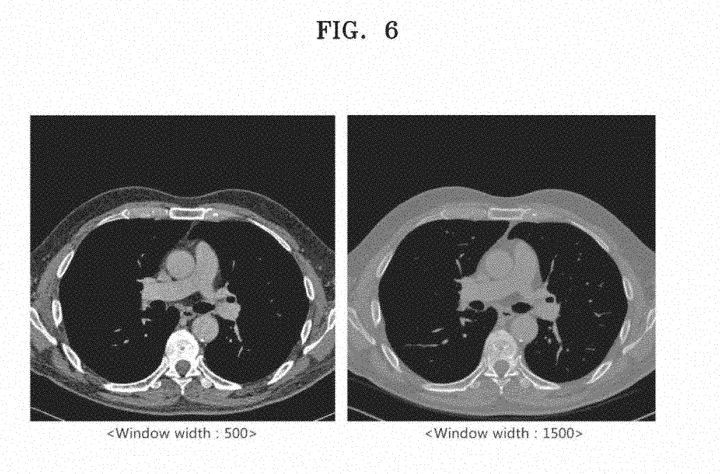

FIGS. 5 and 6 are diagrams illustrating a method of controlling a signal intensity range of a medical image according to an embodiment of the inventive concept.

Referring to FIGS. 5 and 6, the medical image control apparatus may display not only a 3D object having a volume in a virtual space, but also a two-dimensional (2D) medical image as illustrated in FIG. 6, if necessary. Only voxels having a certain range of signal intensity may be displayed in a 2D medical image represented as a contrast of signal intensity. For example, a signal intensity of 300 HU to 700 HU or a signal intensity of 100 HU to 1000 HU may be displayed in the 2D medical image.

In order to control a signal intensity range (window width) (e.g., 500 HU or 1500 HU) displayed in the 2D medical image, the user may press a particular button and move two interface apparatuses 500 and 510 to be close to or apart from each other. In this case, a center of the signal intensity range may not change. That is, when the current signal intensity range is 300 HU to 700 HU, the center ‘500 HU’ thereof may not change and the signal intensity range may increase or decrease with respect to the center ‘500 HU’ of the signal intensity range.

The medical image control apparatus may determine the distance between two interface apparatuses 500 and 510, determine the signal intensity range according to the determined distance, and then display a 2D medical image of the changed signal intensity range.

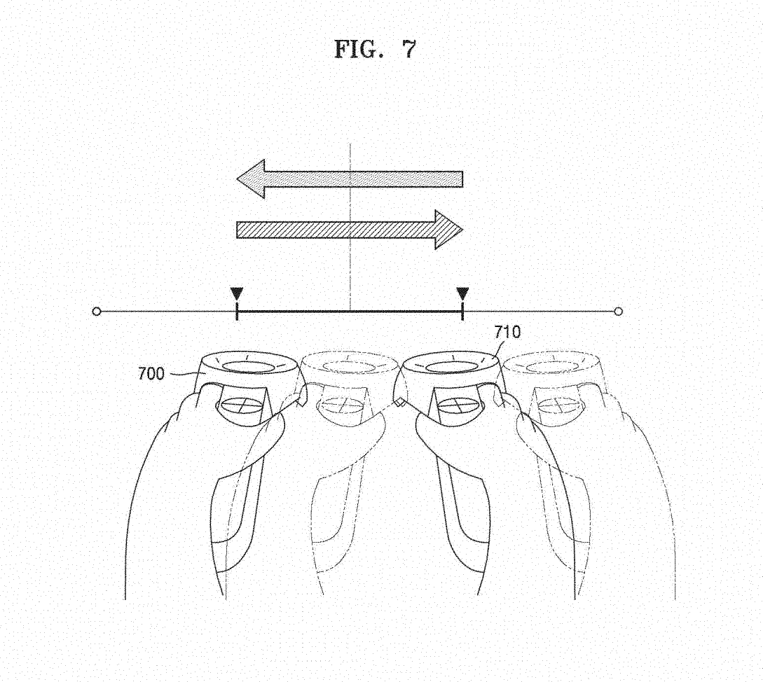

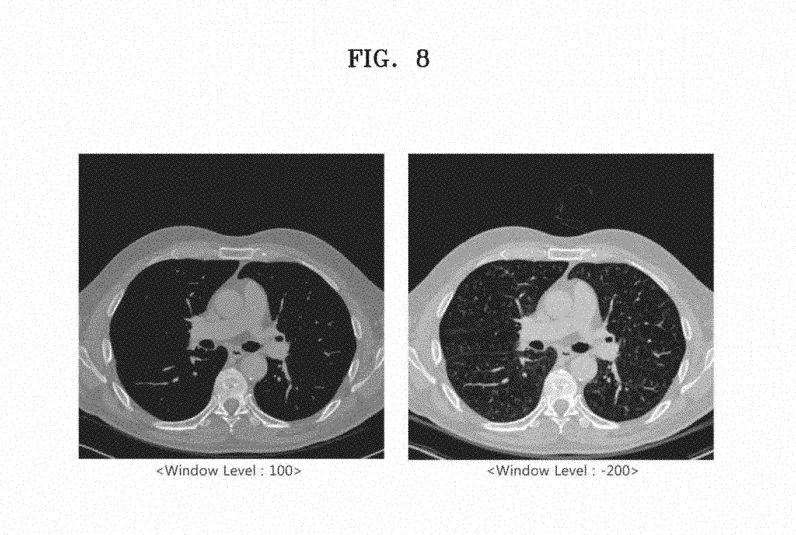

FIGS. 7 and 8 are diagrams illustrating a method of controlling a position of a signal intensity range according to an embodiment of the inventive concept.

Referring to FIGS. 7 and 8, the medical image control apparatus may move the position of the signal intensity range illustrated in FIGS. 5 and 6 through the horizontal movement of two interface apparatuses 700 and 720 in the virtual space. For example, the medical image control apparatus may move the position of the signal intensity range (window width), which is 100 HU to 500 HU, to 200 HU to 600 HU. In this case, the signal intensity range may be maintained at 400 HU.

For example, when two interface apparatuses 700 and 710 move to the left or right while maintaining a certain distance therebetween with a particular button thereof pressed, the medical image control apparatus may move the position of the signal intensity range of a 2D medical image and then display a 2D medical image corresponding to the moved position of the signal intensity range in the virtual space.

As another example, when the distance between two interface apparatuses 700 and 710 changes while two interface apparatuses 700 and 710 move to the left or right with a particular button thereof pressed, the medical image control apparatus may display a 2D medical image in the virtual space, which is obtained by changing both the signal intensity range and the position thereof illustrated in FIGS. 5 and 6.

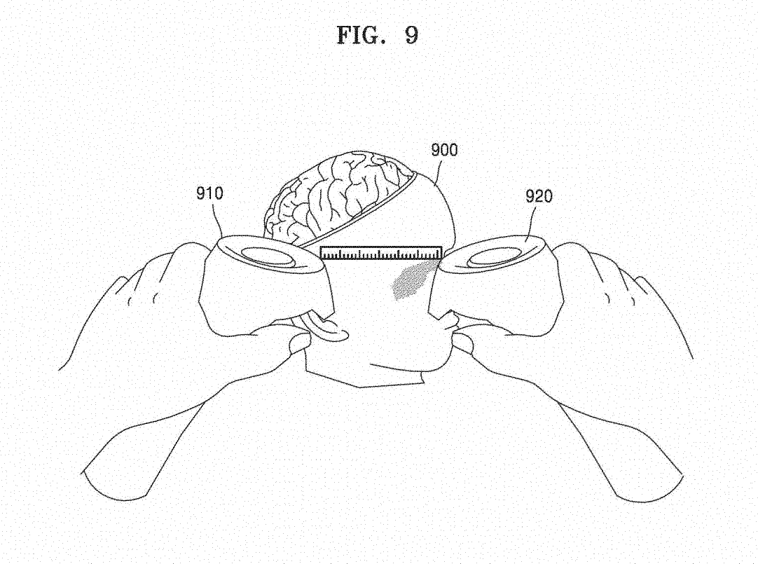

FIG. 9 is a diagram illustrating a method of measuring a distance of a 3D object of a medical image according to an embodiment of the inventive concept.

Referring to FIG. 9, in order to measure the actual distance between two points of a 3D object 900 displayed in the virtual space, the user may press a particular button after moving a particular position of two interface apparatuses 910 and 920 (e.g., a front end of the interface apparatus) to two points of the 3D object 900 to be measured.

The medical image control apparatus display the distance between two interface apparatuses 910 and 920 in the virtual space. In this case, the displayed distance may be an actual distance based on the scale factor of the 3D object.

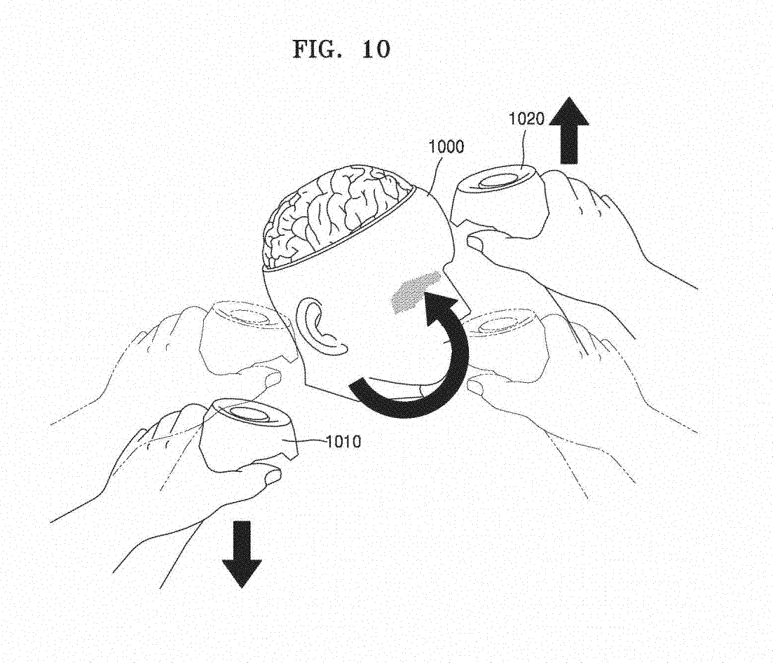

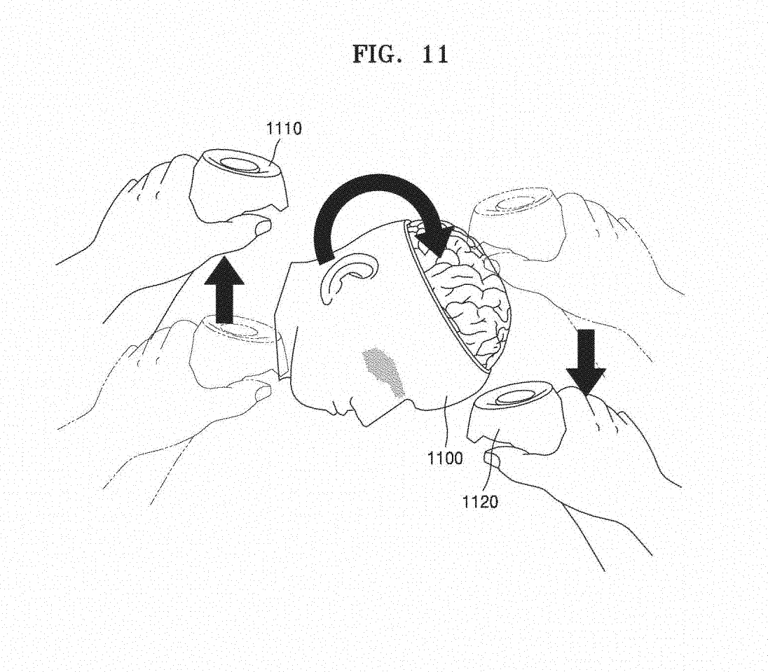

FIGS. 10 and 11 are diagrams illustrating a method of rotating a 3D object of a medical image according to an embodiment of the inventive concept.

Referring to FIGS. 10 and 11, when two interface apparatuses 1010 and 1020 or 1110 and 1120 are moved in different directions in the virtual space, the medical image control apparatus may determine the relative movement direction of two interfaces and then rotate a 3D object 1000 or 1100 accordingly.

FIGS. 12 to 15 are diagrams illustrating a method of displaying a cross section of a 3D object of a medical image according to an embodiment of the inventive concept.

Since a 3D medical image such as a CT image is obtained by capturing X-Y plane images at certain intervals along the Z-axis, it may be easy to display a cross section corresponding to the X-Y plane. When a cross section is located between two X-Y planes or is inclined with respect to the X-Y plane, the cross section may not be displayed only by the X-Y plane image.

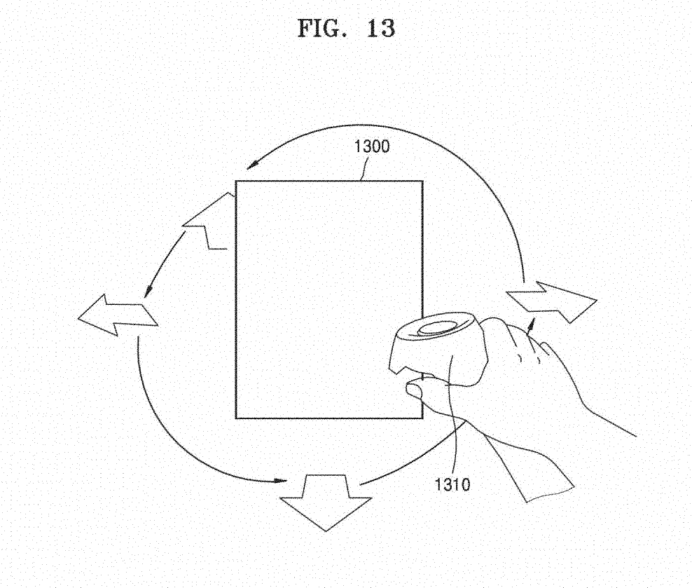

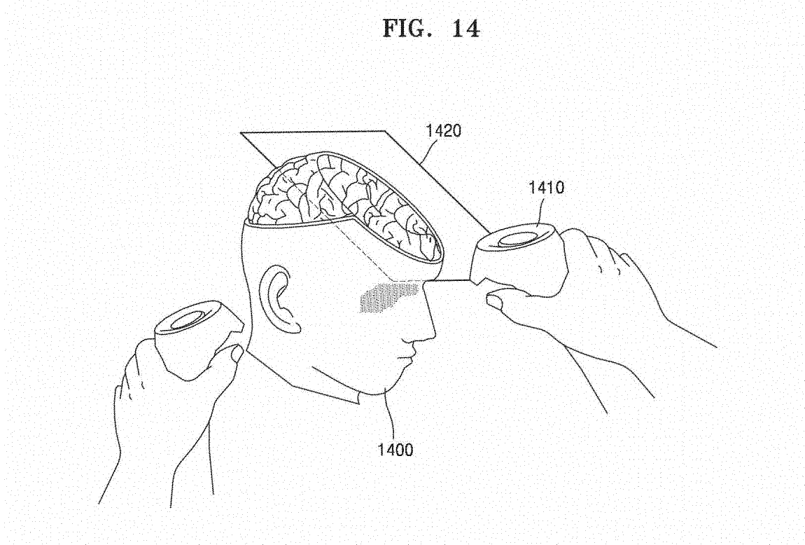

First, a virtual plane used to easily select a cross section desired by the user in the virtual space will be described with reference to FIGS. 12 and 13, and a method of generating an image of a cross section will be described with reference to FIGS. 14 and

Referring to FIG. 12, in order to generate a virtual plane, the medical image control apparatus may receive three or more coordinate values from the user. For example, the medical image control apparatus may display a 2D medical image (i.e., an X-Y plane image) in the virtual space and receive the coordinate of a point selected by the user in the 2D medical image. The user may select the respective coordinate values in one more 2D medical images.

For example, the user may select a first coordinate value P1(x1,y1,z1) in a 2D medical image having a Z-axis value ‘z1’, select a second coordinate value P2(x2,y2,z2) in a 2D medical image having a Z-axis value ‘z2’, and select a third coordinate value P3(x3,y3,z3) in a 2D medical image having a Z-axis value ‘z3’.

When only three coordinate values are selected, the medical image control apparatus may obtain a centroidal coordinate value P4((x1+x2+x3)/3, (y1+y2+y3)/3, (z1+z2+z3)/3) for three coordinate values (P1(x1,y1,z1), P2(x2,y2,z2), P3(x3,y3,z3)) and then obtain a coefficient of a,b,c,d of a plane equation of ax+by+cz+d=0 through singular value decomposition (SVD) and four coordinate values. The medical image control apparatus may display a virtual plane corresponding to the plane equation in the virtual space.

As another example, the medical image control apparatus may receive three or more positions selected from the user in a 3D object represented as a polygon and then generate and display a virtual plane in the virtual space.

Referring to FIG. 13, the medical image control apparatus may provide a predetermined virtual plane 1300 to the user in the virtual space. Through an interface apparatus 1310, the user may control the position or inclination of the virtual plane 1300 generated by the method of FIG. 12 or the method of FIG. 13.

For example, when a particular button is pressed for cross section control, the medical image control apparatus may display the virtual plane 1300 in the virtual space and change the position or inclination of the virtual plane 1300 according to the movement or inclination of the interface apparatus 1310.

Referring to FIG. 14, when an interface apparatus 1410 is moved in the virtual space to move a virtual plane 1420 to a 3D object 1400, the medical image control apparatus may display an image corresponding to a section where the virtual plane 1420 and the 3D object 1400 meet together. The user may easily find a desired region through a cross section displayed in real time by moving the virtual plane 1420.

For cross section display, the medical image control apparatus may determine the signal intensity of a voxel corresponding to the section where the virtual plane 1420 and the 3D object 1400 meet together and then determine and display the color, brightness, or chroma of each coordinate of the cross section based on the determined signal intensity.

For example, the medical image control apparatus may determine each coordinate constituting the section by using the plane equation described above and may determine a voxel corresponding to the coordinate of the section. Also, the medical image control apparatus may generate and display a section image by reflecting the signal intensity of the determined voxel.

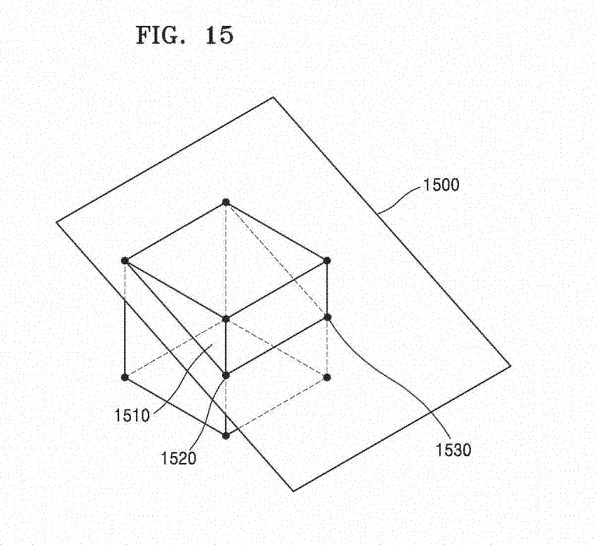

Referring to FIG. 15, there may be a case where the coordinates of the section of a 3D object 1510 meeting a virtual plane 1500 and the coordinates of the voxels of the medical image are not one-to-one matched. For example, the virtual plane 1500 may pass between the voxels or the virtual plane 1500 may be inclined and thus the voxel coordinates do not exist in the section where the virtual plane and the 3D object meet together.

Thus, based on the signal intensity of at least one voxel located within a certain range with respect to each coordinate of the virtual plane 1500 displayed in the virtual space, the medical image control apparatus may determine the color, brightness, or chroma to display the cross section.

For example, the medical image control apparatus may set a region having a certain thickness with respect to the virtual plane 1500, determine a voxel belonging to the space where the region and the 3D object meet together, and display the cross section by using the signal intensity of the voxel around the coordinates of the virtual plane 1500 when there is no voxel matched with the coordinates of the virtual plane 1500 (i.e., the coordinates of the section).

The medical image control apparatus may use interpolation to display the cross section by using the signal intensity of the voxels of at least one medical image located within a certain range with respect to each coordinate of the virtual plane.

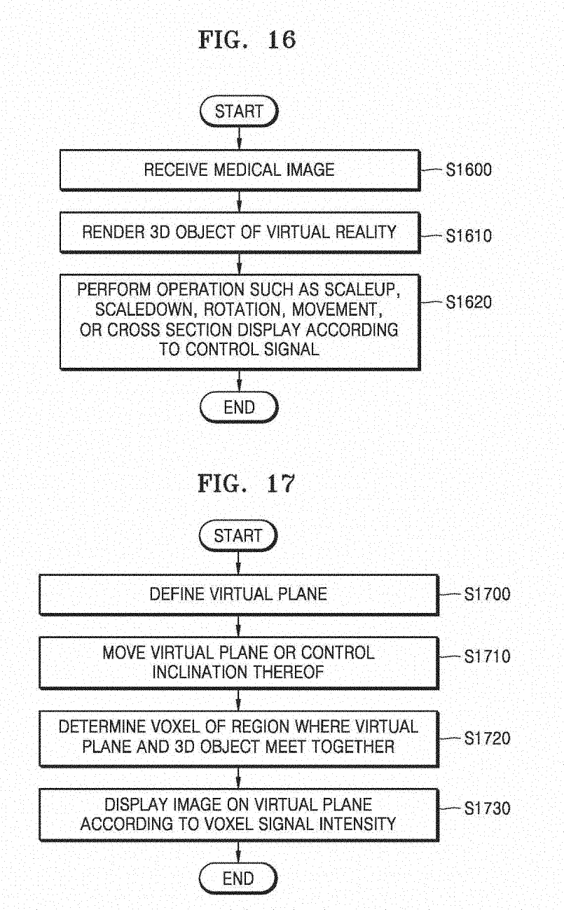

FIG. 16 is a diagram illustrating a flow of an embodiment of a medical image control method according to the inventive concept.

Referring to FIG. 16, the medical image control apparatus may receive a 3D medical image including voxels (S1600). The medical image control apparatus may render and display the medical image as a 3D object of the virtual space (S1610). Then, the medical image control apparatus may capture the user's motion projected in the virtual space and perform various control operations such as movement, scaledown, scaleup, rotation, or cross section display of the 3D object corresponding thereto (S1620).

FIG. 17 is a diagram illustrating a flow of an embodiment of a method of displaying a medical image cross section according to the inventive concept.

Referring to FIG. 17, the medical image control apparatus may define a virtual plane (S1700). The virtual plane may be generated based on three or more coordinate values received from the user, or may be pre-generated and displayed at a predetermined position of the virtual space.

The medical image control apparatus may move the virtual plane in the virtual space or change the inclination thereof according to the movement or the inclination of the interface apparatus (S1710). When the virtual plane meets the 3D object, the medical image control apparatus may determine the signal intensity of the voxels of the medical image corresponding to the section of the 3D object where the virtual plane passes (S1720).

Since the 3D medical image includes voxels, the virtual plane may pass between the voxels according to the position or inclination of the virtual plane. Thus, the medical image control apparatus may determine the signal intensity of the voxels located within a certain range based on the coordinates of the section where the virtual plane and the 3D object meet together. For example, the medical image control apparatus may determine the signal intensity of the voxels of the space where the 3D object and a region having a certain thickness (not the virtual plane) meet together.

Based on the signal intensity of the voxel determined in the section where the virtual plane and the 3D object meet together, the medical image control apparatus may determine the color, brightness, or chroma to display an image of the cross section (S1730).

The inventive concept may also be embodied as computer-readable codes on a computer-readable recording medium. The computer-readable recording medium may be any data storage device that may store data which may be thereafter read by a computer system. Examples of the computer-readable recording medium may include read-only memories (ROMs), random-access memories (RAMs), compact disk read-only memories (CD-ROMs), magnetic tapes, floppy disks, and optical data storage devices. The computer-readable recording medium may also be distributed over network-coupled computer systems so that the computer-readable codes may be stored and executed in a distributed fashion.

According to the inventive concept, it may be possible to render and display a 3D medical image as a 3D object of virtual reality or augmented reality and provide various user interfaces for convenient control (e.g., user's motion capture). Also, the section of a medical image desired by the user may be displayed through a 3D object of virtual reality or augmented reality.

The inventive concept has been particularly shown and described with reference to the exemplary embodiments thereof. However, those of ordinary skill in the art will understand that various changes in form and details may be made therein without departing from the spirit and scope of the inventive concept as defined by the appended claims. Thus, the above embodiments should be considered in descriptive sense only and not for purposes of limitation. Therefore, the scope of the inventive concept may be defined not by the above detailed descriptions but by the appended claims, and all differences within the scope will be construed as being included in the inventive concept.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A method of controlling a medical image, the method comprising:
receiving a medical image;
rendering the medical image into a three-dimensional (3D) object; and
scaling up, scaling down, rotating, or moving the 3D object or displaying a cross section thereof according to a control signal,
wherein the displaying of the cross section comprises:
determining a voxel of the medical image corresponding to a section where a virtual plane and the 3D object meet together; and
determining and displaying color, brightness, or chroma on the virtual plane based on a signal intensity represented by the voxel of the medical image.

2. The method of claim 1, wherein the virtual plane is formed through three coordinate values specified by a user.

3. The method of claim 1, wherein a position or inclination of the virtual plane changes according to a control signal received from a user.

4. The method of claim 1, wherein the determining of the voxel of the medical image comprises:
setting a region having a predetermined thickness with respect to the virtual plane; and
determining the voxel of the medical image belonging to a space where the region and the 3D object meet together.

5. The method of claim 4, wherein the determining and displaying of the color, brightness, or chroma comprises determining and displaying color, brightness, or chroma based on a signal intensity of a voxel of at least one medical image located within a predetermined range with respect to each coordinate constituting the virtual plane.

6. The method of claim 4, wherein the determining and displaying of the color, brightness, or chroma comprises determining color, brightness, or chroma to be displayed at each coordinate of the virtual plane by interpolating a signal intensity of voxels of at least one medical image located within a predetermined range with respect to the each coordinate.

7. An apparatus for controlling a medical image, the apparatus comprising:
an input unit receiving a medical image;
a rendering unit rendering the medical image into a three-dimensional (3D) object; and
a control unit scaling up, scaling down, rotating, or moving the 3D object or displaying a cross section thereof according to a control signal,
wherein when receiving a cross section control signal, the control unit determines color, brightness, or chroma based on a signal intensity represented by a voxel of the medical image corresponding to a section where a virtual plane and the 3D object meet together and displays the determined color, brightness, or chroma on the virtual plane.

8. A non-transitory computer-readable recording medium that stores a program for performing the method of claim 1.
